(19) United States
(12) Patent Application Publication
(10) Pub. No.: US 2007/0254512 A1
(43) Pub. Date: Nov. 1, 2007

(54) Light bulb theft-reduction apparatus and method of use

(75) Inventor: Chou Shih Bin, Taipei (TW)

Correspondence Address: ZITO TLP, P.O. BOX 240, DAMASCUS, MD, 20872, US

(73) Assignee: Canel Lighting Co. Ltd.

(21) Appl. No.: 11/414,935

(22) Filed: May 1, 2006

(51) Int. Cl. H01R 33/08

(52) U.S. Cl. 439/232

(57) ABSTRACT

A light bulb theft reduction apparatus and method of use comprising the substitution of GU10 two-pin socket connections on otherwise standard, common and publicly available electric lighting lamp fixtures for the purposes of rendering them uncommon for use in publicly accessible facilities such as resorts, hotels and motels. The invention further comprises installing non-removable GU10 adapters which permanently render a common light fixture uncommon in cases where GU10-modified fixtures are substituted on existing lamps. The invention further comprises using CFL bulbs manufactured with GU10 bases, thus rendering the bulbs uncommon to the general public but suitable for use with either the GU10 lamp fixtures or the GU10 adapters by owners of guest facilities. The use of the GU10 CFL bulbs in combination with either the GU10 fixtures or adapters constitutes an economical theft-deterrent for CFL bulbs since they cannot be easily or economically used in a traveler's home.

### FIELD OF THE INVENTION

The present invention relates to the field of theft-reduction devices and techniques. More specifically, the present invention is a set of apparatus and method of use involving GU10-modified electric light sockets, bulbs and associated adapters developed for use in publicly accessible places to reduce the incidence of theft of the light bulbs, particularly CFL bulbs.

### BACKGROUND OF THE INVENTION

Public facilities face a constant problem of petty theft. Resorts, hotels and motels in particular have a long history of guests helping themselves to such things as ash trays, hangers, towels and wash cloths, bathrobes and even coffee makers, as these items are typically made available with limited theft deterrent options. Typically the lodging owner wants to provide a comfortable place for a traveler to rest which offers the comforts of home with the same ease of use of supplies and furnishings. This includes providing certain amenities in good faith that the traveler will not take them. Where a guest of facilities pays cash in advance, it is particularly easy for them to walk off with supplies and furnishings in their luggage as they leave check-out.

Lodging owners and developers are constantly on the lookout for new ways to prevent theft. While many ideas abound, a typical tradeoff the owners face is the cost of theft deterrents versus the cost of the theft itself. For example, it makes little sense to place RFID position locating tags on ashtrays and then to install a system for monitoring these tags in the facility because the cost of this type of system would greatly surpass the cost of the normal incidence of theft of the ashtrays. However, it does make sense to install television lock-down devices since the cost of these devices is small compared to the theft of the television sets they prevent.

One item which is constantly a choice of light-fingered people is light bulbs. The developers typically try to provide rooms furnished with table and floor lamps of a variety which are commonly available on the market, and thus are commonly found in the home of the typical traveler. Buying common versus custom-made lamps allows the concept of supply and demand to keep the owners' outlays for the purchase and replacement of these items at the lowest possible price. However, a consequence of using standard lamp furnishings is that the lightbulbs which fit into them are also standard. The bulbs are easily removed by anyone, and since the typical market-standard hotel lamp has a market-standard bulb-holder socket, a light bulb from one of these lamps will fit a common traveler's lamps at his or her home. This provides temptation for a guest of a facility to remove lightbulbs to supplement his or her domestic supply.

This is particularly true of newly developed compact fluorescent lightbulbs (CFLs). CFLs were developed as a more economical and energy-friendly substitute for the common household lightbulb. They are currently manufactured with standard household lightbulb bases and fit standard household lightbulb fixtures. The CFL is more expensive, but it lasts longer, thus making it more economical overall for the purchaser. Because of its greater initial expense, the CFL is more subject to thievery than are standard incandescent bulbs. And also because of its greater expense, it raises the threshold for the cost of worthy theft deterrents.

Unfortunately, there are not many alternatives available to economically prevent theft of lightbulbs in resorts, hotels and motels. The owner may order custom-designed lamps with non-standard light fixtures and bulbs, but this is not practical since with such limited demand, the lamps would most likely be prohibitively costly and the bulbs would tend to be expensive to replace. Security devices might be placed in the lamp socket that would detect the removal of the bulb, but this concept would potentially have as low a return on investment as the RFID concept for ashtrays noted above. Of course, using glue to permanently affix the bulbs in the lamps would have obvious negative ramifications.

Therefore, it remains for inventors to find a practical and economical solution to this problem. The invention of the CFL has created an opportunity for one such solution which is presented below.

### SUMMARY OF THE INVENTION

A light bulb theft-reduction apparatus and method of use is disclosed comprising the substitution of GU10 two-pin socket connections on otherwise standard, common and publicly available electric lighting lamp fixtures for the purposes of rendering them uncommon for use in publicly accessible facilities such as resorts, hotels and motels. For the purposes of this invention, the use of the words ‘standard’ and ‘common’ refer to the extent of availability and use of the elements described within a particular geographical area, such as the American marketplace. The invention further comprises the installation of non-removable GU10 adapters which permanently render a common light fixture uncommon in cases where GU10-modified fixtures are not substituted on existing lamps. The invention further comprises CFL light bulbs manufactured with a GU10 base, thus rendering the bulb uncommon to the general public but suitable for use with either the substituted GU10 lamp fixtures or the installed GU10 adapters by owners of resorts, hotels and motels. The use of the GU10 CFL bulbs in combination with either the GU10 fixtures or adapters constitutes an economical theft-deterrent, reducing the incidence of theft of CFL bulbs since they can no longer be used in a traveler's home.

A first aspect of the invention comprises the substitution of a GU10 two-pin light bulb socket connection within an otherwise standard electric light fixture. The light fixture comprises a bulb-holding housing and a socket. The housing provides an enclosure for the termination of the lamp's internal wiring at the socket, and the socket contains both physical mating features and electrical contacts designed to associate with those of a base of a bulb intended to be installed therein.

In a first embodiment of the first aspect, the GU10 connection is manufactured as part of a basic light fixture. In a second embodiment of the first aspect, the GU10 connection is manufactured within a switched fixture, where the switch is used to turn the light on and off. In a third embodiment, the connection is employed within a screw-ring fixture, where the screw-ring is used to secure a lampshade or its support to the fixture for mounting purposes.

To use this first aspect, a resort, hotel or motel owner or developer may purchase standard marketplace lamps and proceed to retrofit them with the modified fixtures of the above three embodiments. A variety of lightbulbs with connection bases which fit the GU10 sockets are currently available to industrial developers and may be purchased and installed in the modified fixtures. The GU10 bulb versions may be more expensive than the common-use bulbs, but since the majority of homeowners do not have lamps which use this type of socket connection, the bulbs are less subject to theft by overnight guests. Therefore, the return on the investment cost for replacing the fixtures has the potential to be attractive to facility owners and developers.

A second aspect of the invention comprises a non-removable socket adapter which converts a light fixture having a standard household socket to a GU10-socketed fixture. The adapter comprises a male insert and a set of tabs projecting outward from its sides which, when the insert is forced into a conventional socket, prevents the adapter from being removed without ruining either the socket, the adapter or both.

To use the second aspect, the adapter is inserted into the socket of a common light fixture, rendering it uncommon in that it now will accept only GU10-modified light bulbs. The non-removable adapter insert not only provides a way to prevent accidental removal of the adapter when replacing the bulb during normal maintenance, but also prevents a guest from intentionally removing it to take it with him. This forces a guest desirous of stealing and using GU10 light bulbs to purchase corresponding adapters in the marketplace, where they are not likely to be readily available to the general public, thus providing the deterrent against stealing the GU10 light bulbs that fit into them.

In a third aspect of the invention, a standard CFL is modified by manufacturing the bulb with a GU10 two-pin base. In this aspect, the CFL bulb is now able to be used with the modified lamps of the first and/or second aspects of the invention to achieve the same theft deterrent advantage as is achieved for the incandescent bulbs. However, because of the generally greater cost and economic benefit of CFL bulbs, the return on investment to facilities owners and developers for purchasing the GU10-modified CFLs for use with the GU10-modified lamps tends to increase over that of the currently available GU10 incandescent bulbs.

The combinational use of the GU10-modified fixture replacements on existing lamps and/or the standard-to-GU10 converting adapters within existing fixtures of standard lamps in conjunction with the installation of GU10-modified CFL bulbs provides a novel lightbulb theft deterrent methodology to reduce the incidence of theft of the bulbs in resorts, hotels and motels.

### BRIEF DESCRIPTION OF THE DRAWINGS

Exemplary embodiments of the invention are discussed hereinafter in reference to the drawings, in which:

FIG. 1 shows views of each of the three embodiments of the first aspect of the invention—the unswitched, switched and screw ring GU10-modified light fixtures.

FIG. 2 provides two views of the second aspect of the invention—the GU10 socket-converting (common standard-to-GU10) adapter.

FIG. 3 is a view of the GU10-modified compact fluorescent light (CFL) bulb.

FIG. 4 comprises views of component of the unswitched GU10-modified light fixture.

FIG. 5 comprises views of component of the switched GU10-modified light fixture.

FIG. 6 comprises views of component of the screw ring GU10-modified light fixture.

FIG. 7 comprises a pair of views of the bottom section of the screw ring GU10-modified light fixture.

FIG. 8 comprises a pair of views of the connections insert of the screw ring GU10-modified light fixture.

FIG. 9 comprises a depiction of the installation of the GU10 socket-converting adapter.

FIG. 10A comprises a depiction of the installation of the GU10-modified CFL bulb into the GU10-modified light fixtures.

FIG. 10B comprises a depiction of the installation of the GU10-modified CFL bulb into the GU10 socket-converting adapter when the adapter is installed within a common standard light fixture.

FIG. 11A is a depiction of the replacement of a common standard light fixture with a GU10-modified light fixture on a common retail lamp.

FIG. 11B is a depiction of the retail lamp with a GU10-modified light fixture, creating an uncommon standard of lamp for use with GU10 bulbs.

FIG. 12 is a depiction of the method of use of the apparatus of the invention to create a theft-reducing deterrent.

### DETAILED DESCRIPTION OF PREFERRED EXEMPLARY EMBODIMENTS

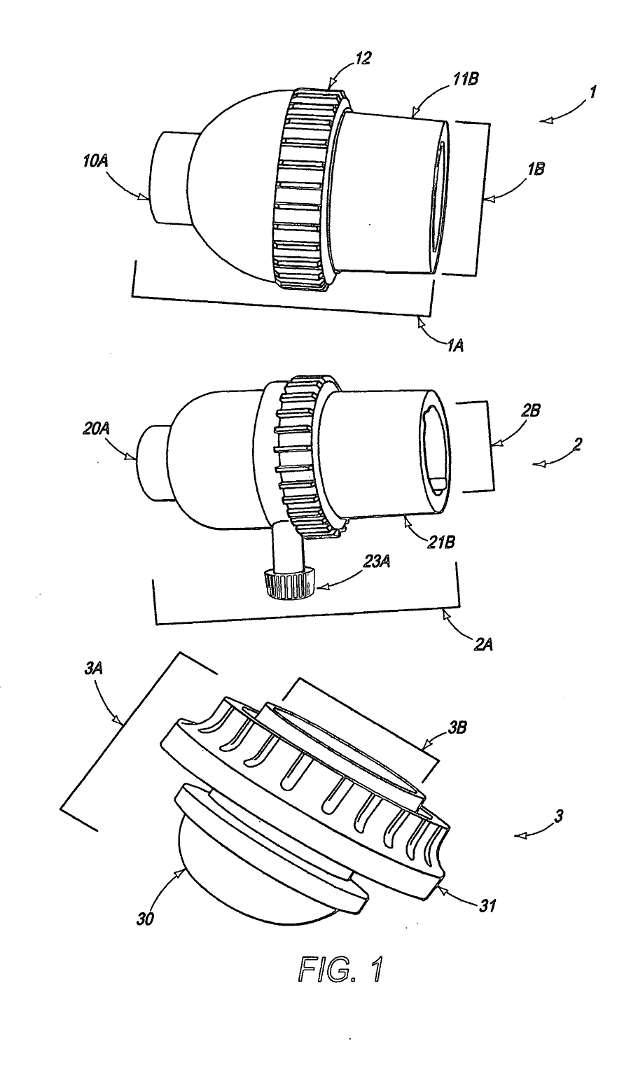

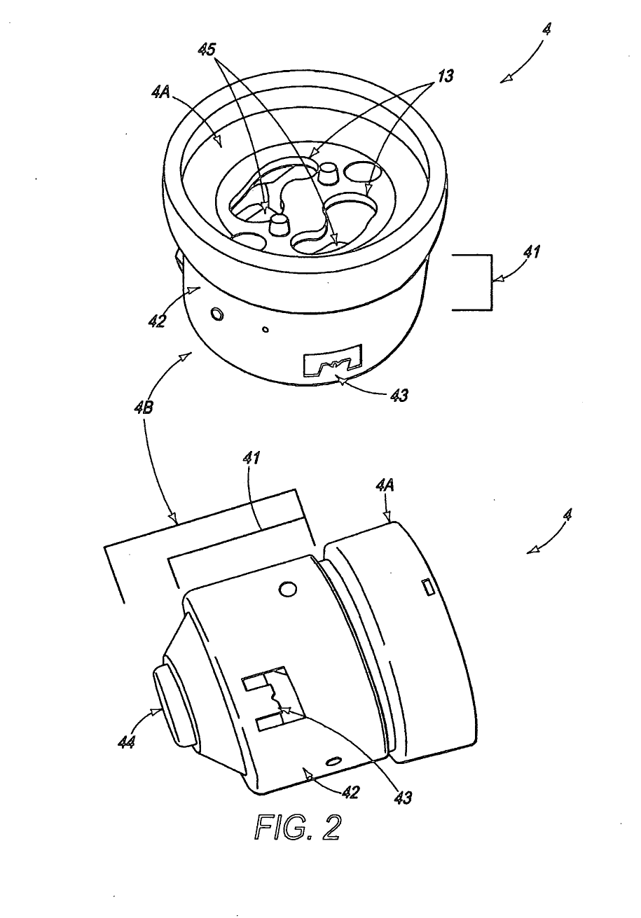

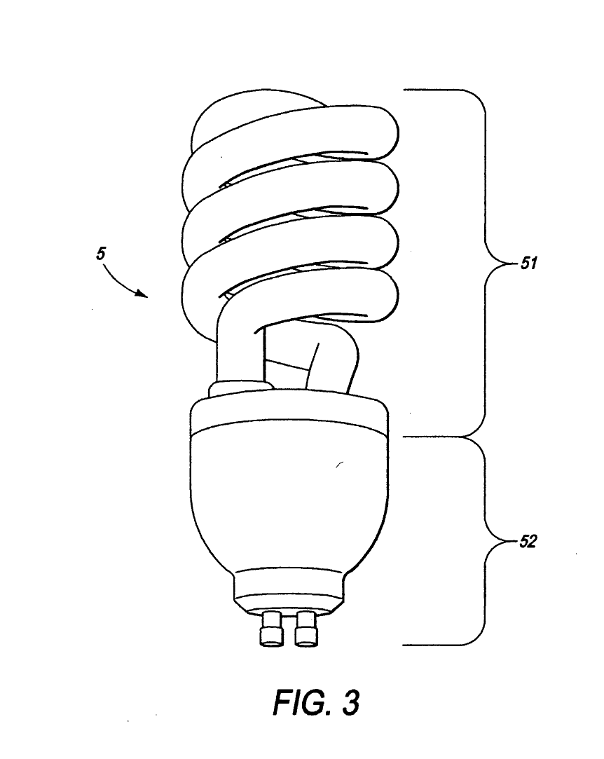

The theft-reduction apparatus of the present invention comprises three separate aspects which when used in combination provide a novel method for reducing the theft of light bulbs from resorts, hotels and motels. As shown in FIG. 1, the first aspect comprises any of a set of GU10-modified light fixtures 1, 2, or 3. As shown in FIG. 2, the second aspect comprises a GU10 socket-converting adapter 4. The third aspect, as shown in FIG. 3 comprises a GU10-modified CFL bulb 5.

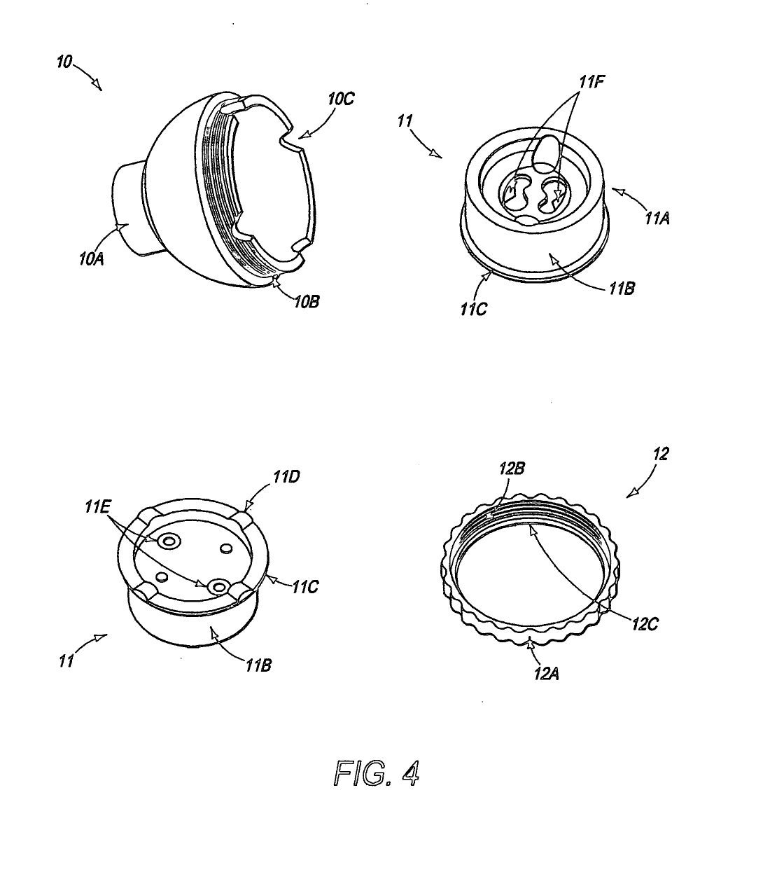

As shown in FIG. 1, a first embodiment of the first aspect comprises an un-switched GU10-modified light fixture 1. The fixture comprises a housing 1A and a socket 1B for holding the base of a light bulb. The housing is made of a phenolic substance, or any other material which is light weight, durable and generally non-conductive of household levels of electricity. It is designed to be installed on common electric lamps, of the variety typically found in retail stores. As shown in FIG. 4, the housing of the first embodiment comprises a bottom section 10, a top section 11 and a ring connector 12.

Bottom section 10 comprises a threaded lamp coupling 10A, designed to engage a standard retail lamp body and a threaded body nipple 10B. The threaded body nipple comprises a series of notches 10C substantially equally spaced about the perimeter of the nipple. Top section 11 comprises socket 11B formed into the bulb connection end 11A of a neck 11B, a fitting lip 11C and a series of nubs 11D. Ring connector 12 comprises a knurled outer surface 12A, a threaded inner surface 12B, and a retaining lip 12C. Contained within neck 11B are connections 11E for the termination of wiring from a lamp upon which the housing is to be mounted and contacts 11F for engagement of the pins of a standard GU10-based light bulb when the bulb is installed in socket 1B. Connections 11E and 11F may be of any type common to typical retail lamp fixtures and are not material to the scope of the invention except to the extent that they are integrated into socket 1B and top section 11 for the purposes of making contact with a GU10-based light bulb installed within the socket.

Socket 1B comprises physical mating features designed to associate with those of light bulbs comprising GU10-standard bases. These features comprise curved slots 13 (see FIG. 2, typical) of the type found in standard GU10 socket connection fittings. The physical mating features are designed to correspond to the contacts 11F contained within neck 11B in a manner known to those skilled in the art of GU10 fixture construction.

To assemble the first embodiment of the first aspect, top section 11 is placed against bottom section 10 in such a way that nubs 11D engage notches 10C. Ring connector 12 is then threaded onto threaded body nipple 10B of bottom section 10 until retaining lip 12C engages fitting lip 11C of the top section.

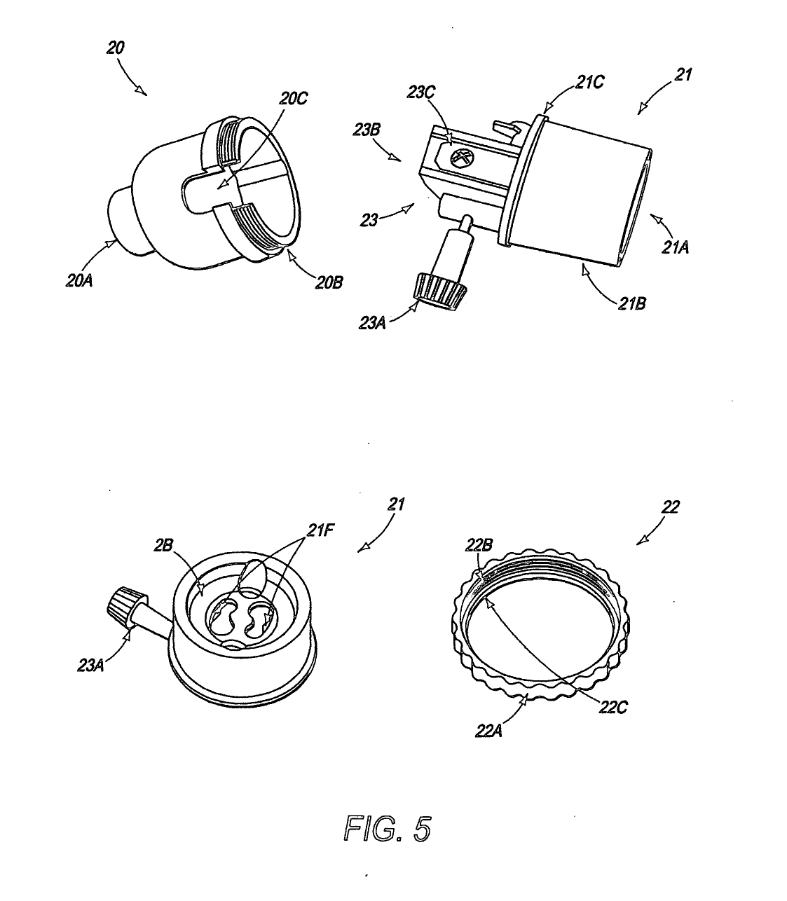

As shown in FIG. 1, a second embodiment of the first aspect of the invention comprises a switched GU10-modified light fixture 2. The fixture comprises a housing 2A and a socket 2B for holding the base of a light bulb. The housing is made of a phenolic substance, or any other material which is light weight, durable and generally non-conductive of household levels of electricity. It is designed to be installed on common electric lamps, of the variety typically found in retail stores. As shown in FIG. 5, the housing of the first embodiment comprises a bottom section 20, a top section 21, a ring connector 22 and a switch compartment 23.

Bottom section 20 comprises a threaded lamp coupling 20A, designed to engage a standard retail lamp body and a threaded body nipple 20B. The bottom section further comprises a positioning slot 20C cut into its side. Top action 21 comprises socket 2B formed into the bulb connection end 21A of a neck 21B and a fitting lip 21C. Ring connector 22 comprises a knurled outer surface 22A, a threaded inner surface 22B, and a retaining lip 22C. Switch compartment 23 comprises a switch thumbscrew 23A, switch circuitry 23B of the type common in these types of fixtures, and connections 23C for the termination of wiring from a lamp upon which the housing is to be mounted. Contained within neck 21B are contacts 21F for engagement of the pins of a standard GU10-based light bulb when the bulb is installed in socket 2B. Connections 23C and 21F may be of any type common to typical retail lamp fixtures and are not material to the scope of the invention except to the extent that they are integrated into socket 2B and top section 21 for the purposes of making contact with a GU10-based light bulb installed within the socket.

Socket 2B comprises physical mating features designed to associate with those of light bulbs comprising GU10-standard bases. These features comprise curved slots 13 (see FIG. 2, typical) of the type found in standard GU10 socket connection fittings. The physical mating features are designed to correspond to the contacts 21F contained within neck 21B in a manner known to those skilled in the art of GU10 fixture construction.

To assemble the second embodiment of the first aspect, top section 21 (with attached switch compartment 23) is placed against bottom section 20 in such a way that thumbscrew 23A engage positioning slot 20C. Ring connector 22 is then threaded onto threaded body nipple 20B of bottom section 20 until retaining lip 22C engages fitting lip 21C of the top section.

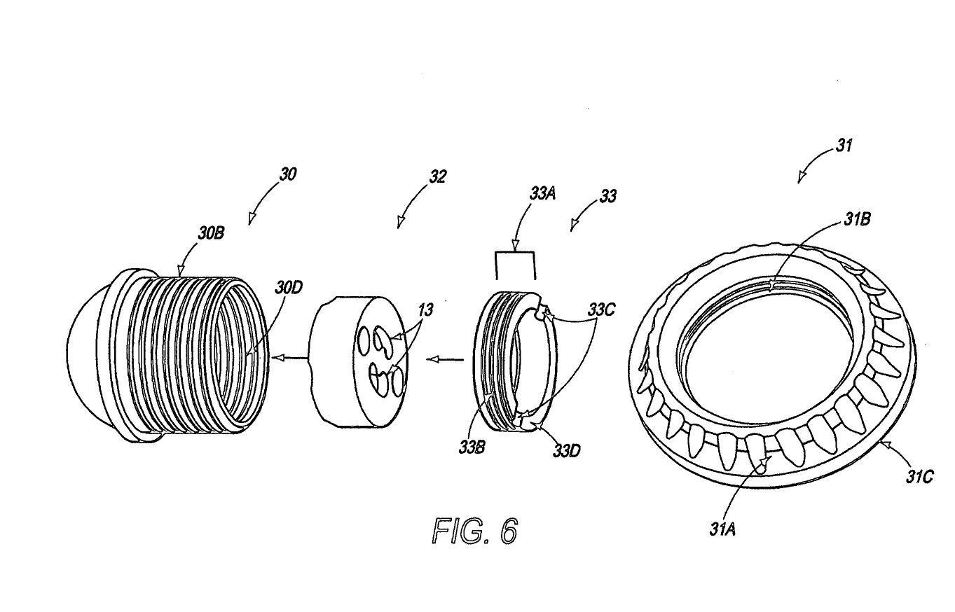

As shown in FIG. 1, a third embodiment of the first aspect comprises a screw-ring GU10-modified light fixture 3. The fixture comprises a housing 3A and a socket 3B for holding the base of a light bulb. The housing is made of a phenolic substance, or any other material which is light weight, durable and generally non-conductive of household levels of electricity. It is designed to be installed on common electric lamps, of the variety typically found in retail stores. As shown in FIG. 6, the housing of the first embodiment comprises a bottom section 30 and a shade connecting ring 31.

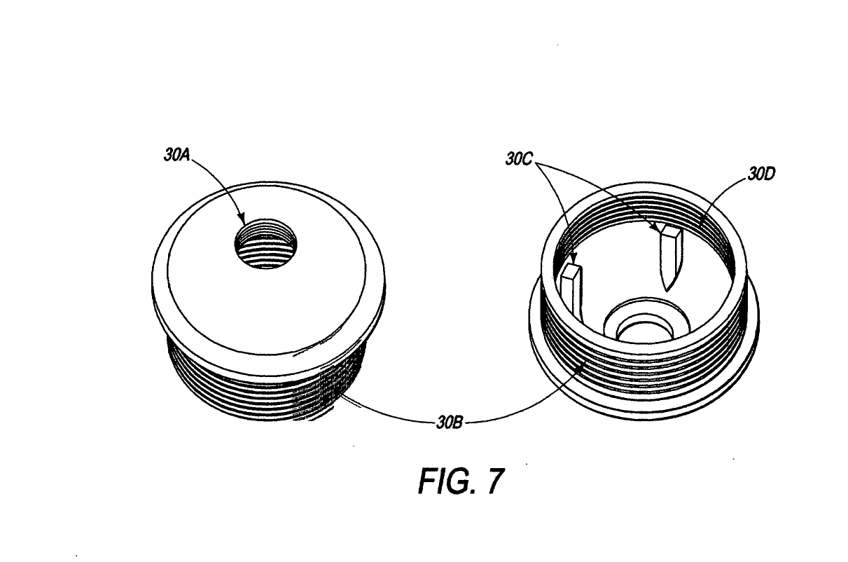

Bottom section 10 comprises a threaded lamp attachment opening 30A, shown in FIG. 7, which is designed to engage a standard retail lamp body and a threaded body nipple 30B. The bottom section further comprises a set of internal threads 30D and series of alignment ridges 30C substantially equally spaced about the internal perimeter of the section, ending just below internal threads 30D. Shade connecting ring 31 comprises a knurled outer surface 31A, a threaded inner surface 31B, and a retaining lip 31C. The purpose of shade connecting ring 31 is to secure the ring of a lamp shade or lampshade support onto the fixture, as is common in the art.

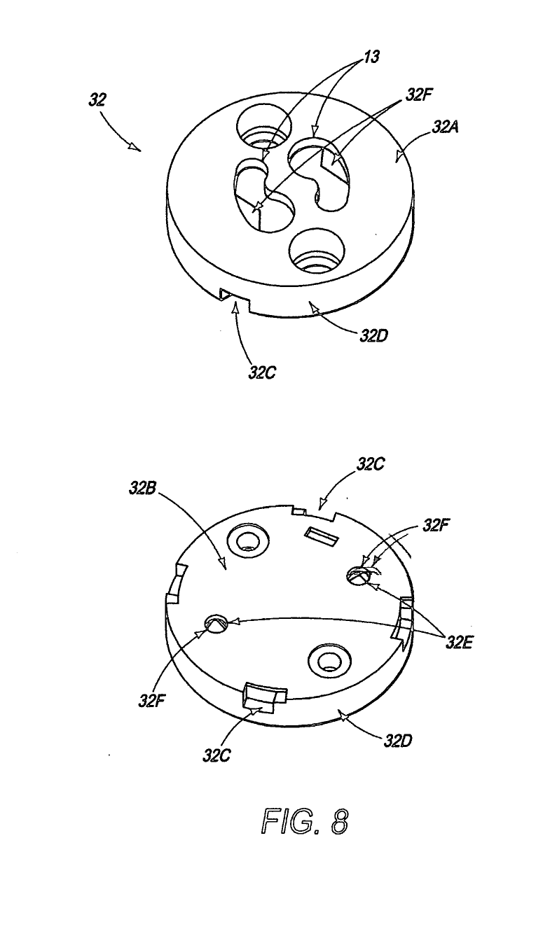

Socket 3B is a two-part component comprising a connections insert 32 and a spacing ring 33. Insert 32 and spacing ring 33 together comprise physical mating features designed to associate with those of light bulbs comprising GU10-standard bases. These features comprise curved slots 13 of the type found in standard GU10 socket connection fittings. As shown in FIG. 8, connections insert 32 comprises a cylindrical unit 32D having a top side 32A and a bottom side 32B. Curved slots 13 are cut into top side 32A. Notches 32C are cut into the corners at the edges of the bottom of the insert such that they traverse a portion of the side of the cylinder. The notches correspond to the locations of ridges 30C of the bottom section, and are used to position the insert within the bottom section.

Housed within the body of cylinder 32D are connections 32E for terminating the wiring from a lamp upon which the housing is to be mounted and contacts 32F for engagement of the pins of a standard GU10-based light bulb when the bulb is installed in socket 3B. A set of wiring ports 32F correspond to the locations of contacts 32E for the lamp wiring terminations, permitting the bare end of a set of wires to penetrate the bottom of the insert and engage connections 32E. Slots 13 in FIG. 8 correspond to the locations of contacts 32F, permitting the pins of a GU10 lightbulb to penetrate the top side of the insert to engage contacts 32F. Connections 32E and 32F may be of any type common to typical retail lamp fixtures and are not material to the scope of the invention except to the extent that they are integrated into socket 3B via connections insert 32 for the purposes of making contact with a GU10-based light bulb installed within the socket.

Spacing ring 33 comprises a short cylinder 33A with external threads 33B and a set of tightening notches 33C on the top side 33D of the ring. The ring serves two purposes. First, when threaded into bottom section 30, on top of connections insert 32, it holds the insert in place where it is fixed on ridges 30C. Second, when threaded into the bottom section, it provides a diameter-reducing function, providing socket 3B with the proper diameter opening to accept the base of a GU10-featured light bulb.

To assemble the third embodiment of the first aspect, as alluded to above, connections insert 32 is slid into bottom section 30 until notches 32C engage ridges 30C. Next spacing ring 33 is threaded into internal threads 30D of the bottom section, securing insert 32 in place. Finally, if the structural ring of a lampshade or lampshade support (not shown, but a common step in the art) has been placed Into position on the bottom section, shade connecting ring 31 is threaded onto the threaded body nipple 30B to secure the lampshade in place.

FIG. 2 illustrates the second aspect of the apparatus, the GU10 socket-converting adapter 4. The adapter comprises a male insert section 4A and a socket 4B. The insert section comprises a cylindrical body 41, made of phenolic or any other material which is light weight, durable and generally non-conductive of household levels of electricity. The insert is sized to be able to easily slide into the socket of a common retail lamp's light bulb holding fixture. The external of body 41 is surrounded by a contact shell 42, which is made of metal or any other relatively stiff conducting material. Shell 42 comprises an interference mechanism which in this embodiment comprises a set of tabs 43 which project outward from the side of the insert such that they do not interfere with inserting the adapter into a common lamp socket, but they do interfere with removing it. The tabs are designed so that the adapter may not be removed by either pulling or twisting, without causing harm to either the adapter, the common lamp socket or both. The FIG. 2 illustrates an outwardly-projecting vertically-oriented tab 43. Other embodiments of the interference mechanism (not shown) are possible, such as an outwardly-projecting horizontally-oriented tab, lip, or any other arrangement which provides a measure of interference from removal of the adapter from the lamp socket. At the end of the insert, there is a contact button 44 which is made of an electricity conducting material and which passes through the end of the male insert and into the body of the adapter. Shell 42 and button 44 perform the contact electricity carrying function commonly associated with similar features found on the male ends of light bulbs which are threaded into common household fixture sockets as is well known in the art. Housed within the body of the adapter is interconnecting circuitry which connects shell 42 and button 44 to contacts 45 within the socket of adapter 4.

Socket 4B comprises physical mating features designed to associate with those of light bulbs comprising GU10-standard bases. These features comprise curved slots 13 (see FIG. 2, typical) of the type found in standard GU10 socket connection fittings. The physical mating features are designed to correspond to contacts 45 contained within the body of adapter 4 in a manner known to those skilled in the art of GU10 fixture construction.

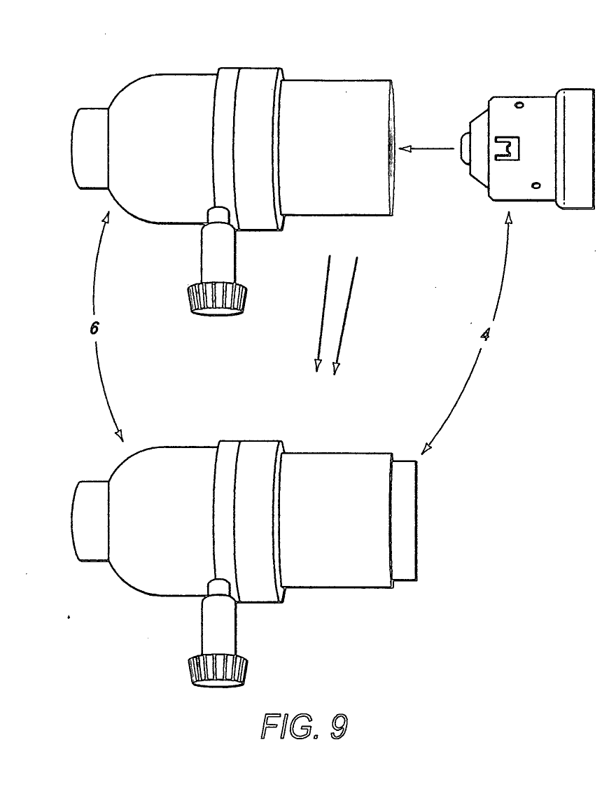

To use adapter 4, as shown in FIG. 9, it is pressed into the end of a screwed-connection light bulb fixture 6 of the kind commonly found in lamps sold in domestic retail stores.

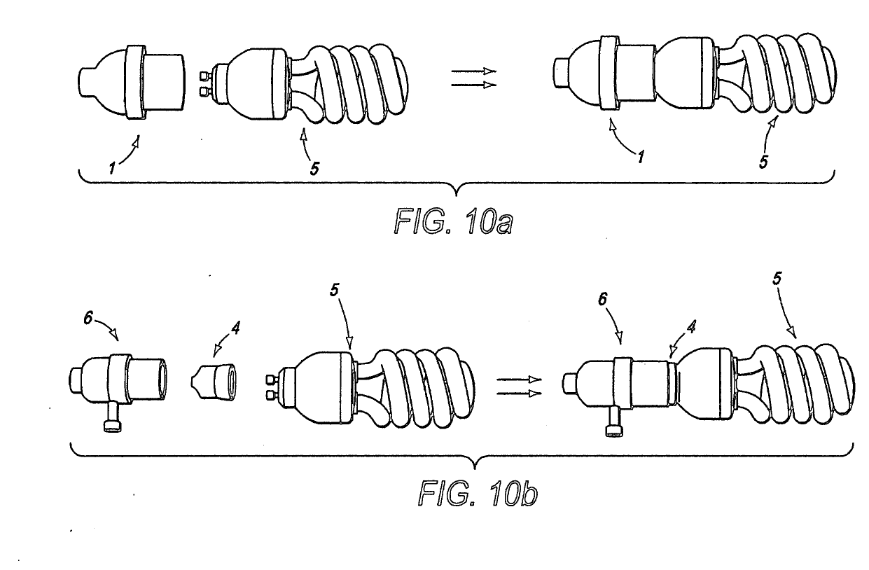

As shown in FIG. 3, CFL bulb 5 comprises the third aspect of the invention. The bulb is a standard CFL spiral vacuum tube 51, mounted on a GU10, two-pin base 52 such that it may be utilized in conjunction with either the first or second aspects of the invention. As is illustrated in FIG. 10A a CFL bulb 5 being used directly with a first aspect GU10-modified un-switched fixture 1. Fixtures 2 and 3 could be substituted in this option with the same effect. FIG. 10B indicates CFL bulb 5 being used indirectly in a standard screwed-connection switched fixture 6. In this option, adapter 4 is first inserted into fixture 6 and then bulb 5 into adapter 4.

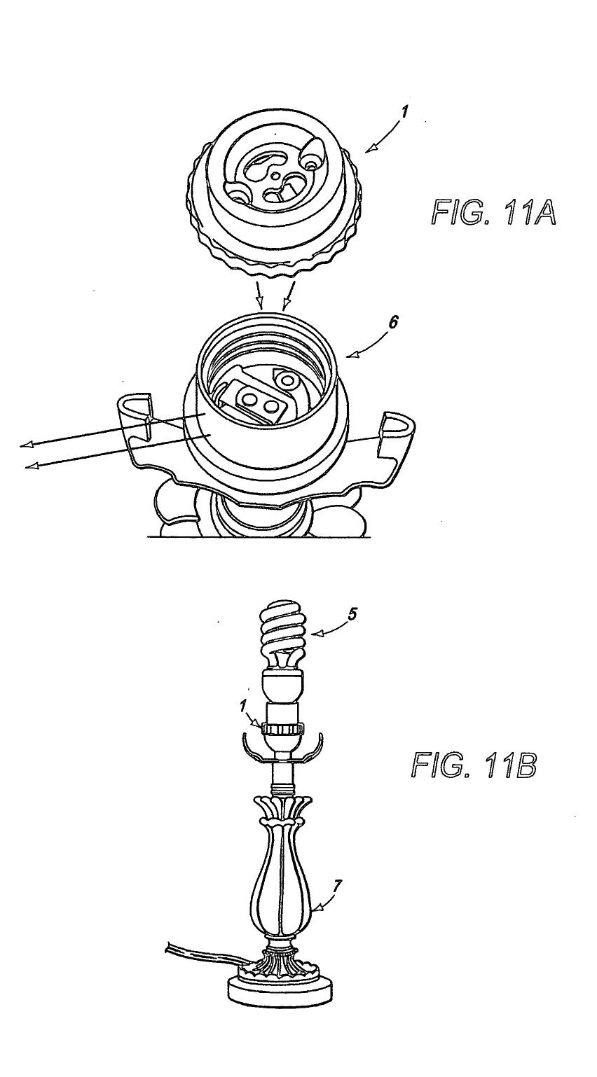

The method of use of the theft reducing apparatus of the present invention comprises two variations which may be utilized either separately or in combination as will be discussed below. In the first variation, a commonly available household lamp with a standard domestic screwed light bulb fixture 6 is modified by removing the standard fixture and replacing it with one of fixtures 1, 2 or 3. FIGS. 11A and 11B illustrates this process for a small table lamp. In FIG. 11A, a first aspect GU10-modified un-switched fixture 1 is substituted for a standard domestic screwed light bulb fixture 6 on a standard domestic lamp 7. This renders the lamp uncommon with respect to typical domestic lamps. With fixture 1 in place on the lamp, GU10 CFL bulb 5 is inserted into the new GU10 fixture as shown in FIG. 11B. This renders theft of the bulb pointless for the average traveling hotel guest since the bulb would not fit his or her personal domestic lamp at home.

In the second variation, as shown in FIG. 10B adapter 4 is pushed into fixture 6 which would be mounted on a standard lamp 7 as depicted in FIG. 11A. The adapter can not be removed without damaging either the adapter, the lamp or both. This renders the lamp uncommon with respect to typical domestic lamps. With adapter 4 in place on the lamp, GU10 CFL bulb 5 is inserted into the adapted GU10 fixture as shown in FIG. 10B. This renders theft of the bulb pointless for the average traveling hotel guest since the bulb would not fit his or her personal domestic lamp at home, and since purchasing an adapter for each lamp at home would be a difficult and costly exercise since the adapters would not be commonly available to the general public in retail outlets.

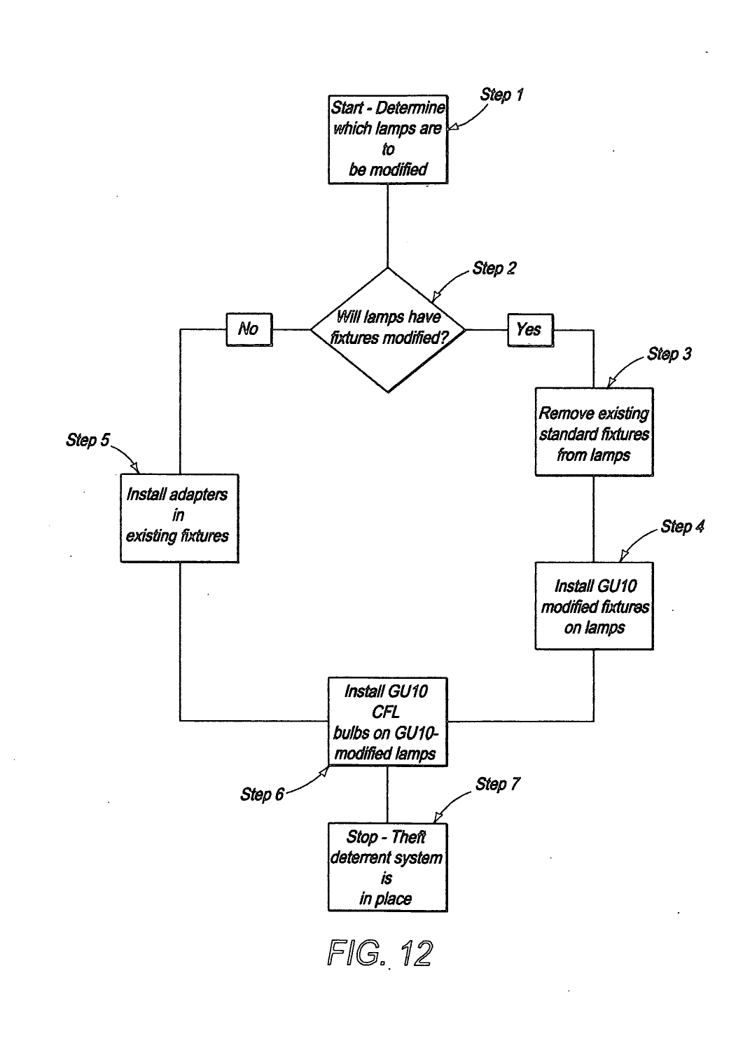

FIG. 12 indicates the method of use process for the theft-reducing invention. In step 1 the facility owner or developer (the “user” of the system) will determine which lamps are to be modified. It is not necessary during this step to decide by which of the above variations they will be modified. In step 2, the user will make a decision if the lamps are to have their existing fixtures removed or not. If they will be removed, the process proceeds to step 3 where the existing fixtures are removed from the base of the lamps. In step 4, the GU10 modified fixtures (either or a combination of fixtures 1, 2 or 3 from FIG. 1) are installed on the fixture-less bases of the lamps from step 3. Next in step 6 GU10-modified CFL bulbs (such as bulb 5 in FIG. 3) are installed in the GU10 sockets of the modified fixtures. The process is now finished with step 7 wherein the theft-deterrent system is in place.

At the decision point in step 2, it is possible that the user will decide to simply install adapters to convert the common lamps to GU10-modified form. In this case, the process passes to step 5, wherein the adapters are installed, and whereupon the process passes to step 6 for installation of the modified CFL bulbs. The process is again finished at step 7 wherein the theft-deterrent system is in place.

It is to be understood that at the decision point in step 2 it is possible for a user to decide to replace some of the lamp fixtures and install the adapter in others without departing from the teachings of the invention.

It is foreseen that a developer may purchase lamps for a new facility directly from a lamp manufacturer. In this case it may be understood that the user would have the option of allowing the manufacturer to simply not install the standard, common lamp fixtures in favor of the GU10 modified fixtures without prejudice to the inventive concept herein taught.

While methods above describe modifications to standard domestic screwed light bulb fixtures, the invention is not limited to only these modifications. The modifications may be made to any lamp where the manufacturers standard of light bulb holding fixture is common in a geographical area and where that standard is not GU10. It is also possible that the inventive system may utilize other standards from GU10 in modifying fixtures and light bulbs. As long as the modifying standard is relatively uncommon in the geographical area of application, the method may be utilized without departing from the teachings of the invention.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A GU10-modified CFL light bulb, comprising:
a compact fluorescent bulb tube assembly operatively connected to
a GU10 two-pin contact base creating a CFL bulb which is able to be operatively installed within a GU10 socket of a light fixture.

2. A light bulb theft-reduction apparatus comprising:
a GU10-modified light fixture which is able to operatively replace a common standard of light fixture installed on a lamp base;
a common standard-to-GU10 adapter which is able to be operatively installed into a common standard of light fixture and which, once installed, is unable to be removed; and
a GU10-modified light bulb, wherein
said common standard comprises a style of light bulb-to-light fixture socket connection that is prevalent in retail stores in a geographic area; and
said light bulb can be installed in at least one of said GU10-modified light fixture and said common standard-to-GU10 adapter creating an uncommon standard for electric lighting lamps wherein
said uncommon standard comprises a style of light bulb-to-light fixture socket connection that is not prevalent in retail stores in a geographic area.

3. A light bulb theft-reduction method comprising:
creating an uncommon standard for electric lighting lamps wherein said uncommon standard comprises a style of light bulb-to-light fixture socket connection that is not prevalent in retail stores in a geographic area; and wherein said uncommon standard further comprises at least one of:
having installed onto a lamp base a GU10-modified light fixture which is able to operatively replace a common standard of light fixture installed on said lamp base; and
having installed within a common standard of light fixture affixed to a lamp base a common standard-to-GU10 adapter which is able to be operatively installed into said common standard of light fixture and which, once installed, is unable to be removed; wherein
said common standard comprises a style of light bulb-to-light fixture socket connection that is prevalent in retail stores in a geographic area; and
installing into at least one said GU10-modified light fixture and common standard-to-GU10 adapter a GU10-modified light bulb.

4. The apparatus of claim 2, wherein said GU10-modified light bulb comprises a GU10-modified CFL light bulb comprising:
a compact fluorescent bulb tube assembly operatively connected to
a GU10 two-pin contact base creating a CFL bulb which is able to be operatively installed within a GU10 socket of a light fixture.

5. The method of claim 3, wherein said GU10-modified light bulb comprises a GU10-modified CFL light bulb comprising:
a compact fluorescent bulb tube assembly operatively connected to
a GU10 two-pin contact base creating a CFL bulb which is able to be operatively installed within a GU10 socket of a light fixture.

6. The apparatus of claim 2, wherein said GU10-modified light fixture comprises one of:
an unswitched GU10-modified light fixture;
a switched GU10-modified light fixture; and
a screw ring GU10-modified light fixture.

7. The method of claim 3, wherein said GU10-modified light fixture comprises one of:
an unswitched GU10-modified light fixture;
a switched GU10-modified light fixture; and
a screw ring GU10-modified light fixture.

8. The apparatus of claim 2, wherein said common standard-to-GU10 adapter comprises:
a male insert;
an electrical contact shell at least partially covering said male insert;
an interference mechanism associated with said shell; and
a GU10 standard light bulb-receiving socket at an outer end of said male insert, wherein
when said male insert is pressed into said common standard light fixture said interference mechanism prevents the removal of said adapter from said common standard light fixture by either pulling or unscrewing.

9. The method of claim 3, wherein said common standard-to-GU10 adapter comprises:
a male insert;
an electrical contact shell at least partially covering said male insert;
an interference mechanism associated with said shell; and
a GU10 standard light bulb-receiving socket at an outer end of said male insert, wherein
when said male insert is pressed into said common standard light fixture said interference mechanism prevents the removal of said adapter from said common standard light fixture by either pulling or unscrewing.

10. The apparatus of claim 6 wherein said unswitched GU10-modified light fixture comprises:
a bottom section comprising a series of notches;
a top section fitting against said bottom section, comprising a series of nubs arranged to engage respective said notches for the purpose of alignment and electrical interconnections for power supply and load contacts; and
a ring connector for holding said bottom and top sections together, wherein
said top section comprises a GU10 socket with slots corresponding to said load contacts, and
said bottom section may affix to a lamp base creating said uncommon standard for said unswitched GU10-modified light fixture.

11. The apparatus of claim 6 wherein said switched GU10-modified light fixture comprises:
a bottom section comprising a positioning slot;
a top section fitting against said bottom section comprising electrical interconnections for power supply and load contacts;
a switch compartment comprising a switch thumbscrew positioned for engagement of said positioning slot for the purpose of alignment, and
a ring connector for holding said bottom and top sections together, wherein
said top section comprises a GU10 socket with slots corresponding to said load contacts, and
said bottom section may affix to a lamp base creating said uncommon standard for said switched GU10-modified light fixture.

12. The apparatus of claim 6 wherein said screw ring GU10-modified light fixture comprises:
a bottom section comprising an externally threaded body nipple, a set of threads internal to the outer end of said nipple and a series of alignment ridges at the inner end of said internal threads;
a connections insert, comprising a cylindrical unit having a top and bottom side, electrical interconnections for power supply and load contacts, a set of wiring ports corresponding to said power supply contacts, slots corresponding to said load contacts and a set of corner notches cut into said bottom side corresponding to respective said alignment ridges; and
a spacing ring, comprising a set of external threads corresponding to said internal threads of said nipple and having an internal diameter corresponding to the external diameter of the base of a GU10 light bulb, wherein
said connections insert fits inside said body nipple on said alignment ridges and said spacing ring threads into said body nipple until it engages said connections insert, and wherein
said spacing ring and connections insert together comprise a GU10 socket, and
said bottom section may affix to a lamp base creating said uncommon standard for said screw ring GU10-modified light fixture.

13. The method of claim 7 wherein said unswitched GU10-modified light fixture comprises:
a bottom section comprising a series of notches;
a top section fitting against said bottom section, comprising a series of nubs arranged to engage respective said notches for the purpose of alignment and electrical interconnections for power supply and load contacts; and
a ring connector for holding said bottom and top sections together, wherein
said top section comprises a GU10 socket with slots corresponding to said load contacts, and
said bottom section may affix to a lamp base creating said uncommon standard for said unswitched GU10-modified light fixture.

14. The method of claim 7 wherein said switched GU10-modified light fixture comprises:
a bottom section comprising a positioning slot;
a top section fitting against said bottom section comprising electrical interconnections for power supply and load contacts;
a switch compartment comprising a switch thumbscrew positioned for engagement of said positioning slot for the purpose of alignment, and
a ring connector for holding said bottom and top sections together, wherein
said top section comprises a GU10 socket with slots corresponding to said load contacts, and
said bottom section may affix to a lamp base creating said uncommon standard for said switched GU10-modified light fixture.

15. The method of claim 7 wherein said screw ring GU10-modified light fixture comprises:
a bottom section comprising an externally threaded body nipple, a set of threads internal to the outer end of said nipple and a series of alignment ridges at the inner end of said internal threads;
a connections insert, comprising a cylindrical unit having a top and bottom side, electrical interconnections for power supply and load contacts, a set of wiring ports corresponding to said power supply contacts, slots corresponding to said load contacts and a set of corner notches cut into said bottom side corresponding to respective said alignment ridges; and
a spacing ring, comprising a set of external threads corresponding to said internal threads of said nipple and having an internal diameter corresponding to the external diameter of the base of a GU10 light bulb, wherein
said connections insert fits inside said body nipple on said alignment ridges and said spacing ring threads into said body nipple until it engages said connections insert, and wherein
said spacing ring and connections insert together comprise a GU10 socket, and
said bottom section may affix to a lamp base creating said uncommon standard for said screw ring GU10-modified light fixture.

16. The apparatus of claim 8, wherein said interference mechanism comprises a set of tabs projecting outward from said shell.

17. The method of claim 9, wherein said interference mechanism comprises a set of tabs projecting outward from said shell.
